(19) United States
(12) Patent Application Publication
(10) Pub. No.: US 2024/0146460 A1
(43) Pub. Date: May 2, 2024

(54) Method for Code Block Group Based Channel Quality Indicator Calculations

(71) Applicant: Nokia Technologies Oy, Espoo (FI)

(72) Inventors: Abolfazl AMIRI, Aalborg (DK); Klaus Ingemann PEDERSEN, Aaborg (DK)

(21) Appl. No.: 18/486,311

(22) Filed: Oct. 13, 2023

Related U.S. Application Data
(60) Provisional application No. 63/415,714, filed on Oct. 13, 2022.

(51) Int. Cl. H04L 1/1809; H04L 1/00; H04L 1/1812

(52) U.S. Cl. CPC H04L 1/1809; H04L 1/0026; H04L 1/1812

(57) ABSTRACT

A method and apparatus to perform receiving, by the apparatus from a communication network, information includes an indication to configure enhanced channel quality indicator configuration reporting; based on the information, formulating calculations of channel quality indicator configurations to determine a level of an error probability condition for at least one code block group of a plurality of code block groups of a plurality of channel quality indicator indexes from the communication network; and based on the formulated calculations, determining a level of an error probability condition for at least one code block group at different channel quality indicator indexes of the plurality of channel quality indicator indexes based on how much an N failed code block group out of M code block group failures associated with a channel quality indicator index is exceeding or not exceeding a parameter P predetermined threshold.

### TECHNICAL FIELD

The teachings in accordance with the exemplary embodiments as disclosed herein relate generally to improved link adaptation (LA) for extended reality (XR) use cases, where code block group (CBG) based Hybrid Automatic Repeat request (HARQ) is applied, more specifically, relate to a low complexity method to reduce the number of multiplications while calculating channel quality indicator feedback tailored for code block group transmissions.

### BACKGROUND

This section is intended to provide a background or context to the invention that is recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

Certain abbreviations that may be found in the description and/or in the Figures are herewith defined as follows:
AR Augmented reality
CBG Code Block Group
CBGTI Code Block Group Transmit Indicator
CSS Common search space
DCI Downlink control information
DL Downlink
fps Frames per second
gNB 5G Node B, base station
KPI Key performance indicator
LA Link Adaptation
MCS Modulation and Coding Scheme
MR Mixed reality
NDI New Data Indicator
NR New Radio
OR Odds Ratio
PDB Packet delay budget
PDCCH Physical downlink control channel
PDSCH Physical downlink shared channel
QoS Quality of service
RRC Radio Resource Control
RV Redundancy Version
SI Study Item
SID Study Item Description
SINR Signal to Interference Noise Ratio
SPS Semi-persistent Scheduling
TB Transport Block
UE User Equipment
USS UE specific Search Space
VR Virtual reality
WI Work Item
XR Extended reality

Various options for CQI feedbacks exist in 5G NR. The standardized NR physical layer UE procedures for reporting CQI appears (where the defined CQI index tables also appears), while more details on PHY layer measurements (incl. CSI-RS) are captured, and a higher layer configuration which CQI format to use happens via RRC signalling as specified in standards at the time of this application.

However, it is noted that in all standardized CQI determination procedures, at the time of this application there is no notion of an improved CQI scheme that is tailored for high data rate cases (such as XR) where CBG-based transmission are used.

Example embodiments as disclosed herein work to address at least this shortfall of the standardized CQI determination procedures.

### SUMMARY

This section contains examples of possible implementations and is not meant to be limiting.

In an example aspect as disclosed herein, there is an apparatus, such as a user equipment side apparatus, comprising: at least one processor; and at least one non-transitory memory storing instructions, that when executed by the at least one processor, cause the apparatus at least to perform: receiving, by the apparatus from a communication network, information comprising an indication to configure enhanced channel quality indicator configuration reporting; based on the information, formulating calculations of channel quality indicator configurations to determine a level of an error probability condition for at least one code block group of a plurality of code block groups of a plurality of channel quality indicator indexes from the communication network; based on the formulated calculations, determining a level of an error probability condition for at least one code block group at different channel quality indicator indexes of the plurality of channel quality indicator indexes based on how much an N failed code block group out of M code block group failures associated with a channel quality indicator index is exceeding or not exceeding a parameter P predetermined threshold, wherein the channel quality indicator configuration calculations are using a linear complexity relation with regards to parameter M and N, and wherein the channel quality indicator configuration calculations are configured to prevent performing repeated operations so operations of the channel quality indicator index calculations are performed only one time for a channel quality indicator index; and based on the determining, reporting a channel quality indicator index with an error probability condition that is lowest of the plurality of channel quality indicator indexes to the communication network for pending link adaptation decisions for physical downlink shared channel communications.

In another example aspect as disclosed herein, there is a method comprising: receiving, by a user equipment from a communication network, information comprising an indication to configure enhanced channel quality indicator configuration reporting; based on the information, formulating calculations of channel quality indicator configurations to determine a level of an error probability condition for at least one code block group of a plurality of code block groups of a plurality of channel quality indicator indexes from the communication network; based on the formulated calculations, determining a level of an error probability condition for at least one code block group at different channel quality indicator indexes of the plurality of channel quality indicator indexes based on how much an N failed code block group out of M code block group failures associated with a channel quality indicator index is exceeding or not exceeding a parameter P predetermined threshold, wherein the channel quality indicator configuration calculations are using a linear complexity relation with regards to parameter M and N, and wherein the channel quality indicator configuration calculations are configured to prevent performing repeated operations so operations of the channel quality indicator index calculations are performed only one time for a channel quality indicator index; and based on the determining, reporting a channel quality indicator index with an error probability condition that is lowest of the plurality of channel quality indicator indexes to the communication network for pending link adaptation decisions for physical downlink shared channel communications.

A further example embodiment is an apparatus and a method comprising the apparatus and the method of the previous paragraphs, wherein the channel quality indicator index calculations are searching for the channel quality indicator index with an error probability lower than a target error threshold parameter P to be reported, comprising minimizing a size of a search space to find the channel quality indicator index, wherein minimizing a size of a search space is using a binary search among different channel quality indicator indexes to find the channel quality indicator index for reporting, wherein the search is performed until a highest channel quality indicator index with an error probability below an error target is found, wherein the minimizing a size of a search space is beginning from an index F/2, wherein based on a maximum of N failed code block group out of the M code block group failures not exceeding the parameter P predetermined threshold a next chosen index is between the index F/2 and F, wherein based on the probability of at most N failed code block group out of M (total number of code block groups within a transport block) exceeding the parameter P a next chosen index is between 0 and F/2, wherein the calculations are regulating a comparison condition of Pₑ(r, N)<P to |Pₑ(r, N)−δ|<P where δ is limiting an error probability variation, wherein a probability of failure of N code block groups of the plurality of code block groups is summed for all the cases of N=0, 1, . . . N, wherein the apparatus compares this expression with a given target P, and wherein if Pₑ(r, N)<P and r is a highest value channel quality indicator index that can meet a maximum error probability below parameter P condition, then r is selected as the channel quality indicator index reported to the communication network for the pending link adaptation decisions, wherein the channel quality indicator configuration calculations comprises a calculation comprising:

$${P}_{e} ( r , N ) = \frac{1}{N !} {{\sum }^{N}}_{N = 0} ( 1 - {p}_{{m}_{N + 1}^{r}} ) \qquad ( equation 1 )$$

and/or wherein the apparatus is embodied in a user equipment of the communication network.

A non-transitory computer-readable medium storing program code, the program code executed by at least one processor to perform at least the method as described in the paragraphs above.

In another example aspect as disclosed herein, there is an apparatus comprising: means for receiving, by a user equipment from a communication network, information comprising an indication to configure enhanced channel quality indicator configuration reporting; means, based on the information, for formulating calculations of channel quality indicator configurations to determine a level of an error probability condition for at least one code block group of a plurality of code block groups of a plurality of channel quality indicator indexes from the communication network; means, based on the formulated calculations, for determining a level of an error probability condition for at least one code block group at different channel quality indicator indexes of the plurality of channel quality indicator indexes based on how much an N failed code block group out of M code block group failures associated with a channel quality indicator index is exceeding or not exceeding a parameter P predetermined threshold, wherein the channel quality indicator configuration calculations are using a linear complexity relation with regards to parameter M and N, and wherein the channel quality indicator configuration calculations are configured to prevent performing repeated operations so operations of the channel quality indicator index calculations are performed only one time for a channel quality indicator index; and means, based on the determining, for reporting a channel quality indicator index with an error probability condition that is lowest of the plurality of channel quality indicator indexes to the communication network for pending link adaptation decisions for physical downlink shared channel communications.

In the example aspect as disclosed herein according to the paragraph above, wherein at least the means for receiving, formulating, determining, using, configuring, and reporting comprises a non-transitory computer readable medium encoded with a computer program executable by at least one processor.

A communication system comprising the network side apparatus and the user equipment side apparatus performing operations as described above.

### BRIEF DESCRIPTION OF THE DRAWINGS

The above and other aspects, features, and benefits of various embodiments of the present disclosure will become more fully apparent from the following detailed description with reference to the accompanying drawings, in which like reference signs are used to designate like or equivalent elements. The drawings are illustrated for facilitating better understanding of the embodiments of the disclosure and are not necessarily drawn to scale, in which:

FIG. 1 shows a signaling flow between a serving cell gNB and a UE;

FIG. 2A and FIG. 2B each show an algorithm for eCQI determination using the novel low-complexity solutions with a binary search of CQI indices;

FIG. 3 shows a complexity comparison for a maximum number of failed CBGs (N) of a proposed low complexity method with baseline schemes in terms of multiplications;

FIG. 4 shows probability calculations in accordance with example embodiments as disclosed herein;

FIG. 5 shows a high level block diagram of various devices used in carrying out various aspects as disclosed herein; and

FIG. 6 shows a method in accordance with example embodiments as disclosed herein which may be performed by an apparatus.

### DETAILED DESCRIPTION

In example embodiments as disclosed herein there is proposed at least a method and apparatus to perform a low complexity method to reduce the number of multiplications while calculating channel quality indicator feedback tailored for code block group transmissions.

Example embodiments as disclosed herein are related to improved link adaptation (LA) for extended reality (XR) use cases, where code block group (CBG) based Hybrid Automatic Repeat request (HARQ) is applied. More specifically, there is proposed a new low complexity method to reduce the number of multiplications while calculating CQI feedback tailored for CBG transmission. This type of CQI format (we call it eCQI) is enhanced to fit with use cases where CBG transmissions are applied, for example XR use-cases. In accordance with example embodiments as disclosed herein a low complexity method is facilitating the implementation of eCQI, as it requires less computational power and consequently has a lower power consumption. The example embodiments as disclosed herein can be relevant for 5G-Advanced standards enhancements for XR as submitted by the applicant. Notice that also during the submissions, for standards at the time of this application, on XR over NR some companies proposed to have improved CQI feedback schemes to better serve XR traffic. However, at that time, no specific solutions were proposed. 6G will see similar requirements for the effective handling of very large payloads and ideas are assumed to be applicable there as well. However, short term use is expected to be in 5G-Advanced.

Current CQI reporting feedback schemes developed for 5G new radio (NR) try to find the highest modulation and coding scheme (MCS) to keep the block error rate (BLER) of the first transmission under a certain target. These legacy methods are designed to work with transport block (TB) based transmission where a full TB is retransmitted in case of errors, and hence it made sense to have a CQI feedback that expresses the recommended MCS for a certain BLER of the first transmission of the TB. However, for the CBG based transmission, it is more interesting to control the maximum number of failed CBGs in order to make sure the retransmission of the failed CBGs can happen within the packet delay budget (PDB) of the XR services (for example 5-15 ms.). Thus, such eCQI scheme guides the gNB on the selection of a maximum MCS index to ensure that only a certain maximum subset of CBGs will need retransmission with a controllable probability. For instance, it can have a CQI scheme that guides the gNB to use a MCS index such that at most 4 CBGs (out of 8 CBGs) will require retransmission with P=0.1 probability (10%). However, to find this index and calculations to find the probability can be tedious and requires high computational power compared to legacy CQI determination at the UE side. For example, for the same case of having at most 4 out of 8 CBGs failing with a certain probability, the UE has to calculate around 155 expressions for each CQI index to see if that index is suitable or not. Therefore, from UE point of view, calculating all these steps may result in higher power consumption or even missing the deadline on sending a timely CQI. The latter case can potentially lead to an improper MCS selection and scheduling decision form the gNB side that can heavily affect the quality of service (QoS) of high throughput services such as XR. Thus, example embodiments propose a low complexity method for the UE to determine the right CQI index while using eCQI scheme that is tailored for CBG-based transmission use cases.

Using CBG-based HARQ is first introduced in 5G NR, and aspects of CBG-based transmissions appear in the MAC specification are specified in standards at the time of this application. In short, the main principle is that a TB is organized into multiple Code Blocks (CBs). In 5G NR, the he maximum size of a CB is 8448 bits. Then, CBs are grouped into CBGs. An additional 24-bit CRC is added at the end of each code block when there is a segmentation. Though there is no limit on the maximum number of CBs in one CBG, there is at least one CB at each CBG. After each TB transmission, the receiver provides feedback for each of the CBGs, and only the erroneously received CBGs are thereafter retransmitted by the transmitter. Error in CBGs can occur if at least one CB from that CBG is in error (failed CB CRC check). For transmission of large TB for XR use cases as defined in standards at the time of this application, cases with 8 CBGs per TB are supported by current NR specs. In general, the maximum number of CBGs per TB is configurable as M∈{2, 4, 6, 8} for the PDSCH.

As similarly stated above, various options for CQI feedbacks exist in 5G NR. For instance, basic LTE-like CQI schemes were standardized corresponding to a BLER target of 0.1 (10%), including options for wideband and frequency selective CQI. Furthermore, cases with the so-called Best-M frequency selective CQI scheme were standardized, where the indicated MCS index corresponds to the channel quality of the best M sub-bands. For NR, the UE is typically configured to measure its channel quality on the CSI-RS resources to determine which MCS index it can support, subject to its first transmission BLER constraint (which by default is 10%). In Rel-16 additional CQI Tables for other BLER targets such as 10⁻⁵ as required for some IIoT use cases were standardized. In standards at the time of this application further CQI enhancements to enable 4-bit sub-band CQI feedbacks were introduced. The standardized NR physical layer UE procedures for reporting CQI appears (where the defined CQI index tables also appears), while more details on PHY layer measurements (incl. CSI-RS) are captured, and a higher layer configuration which CQI format to use happens via RRC signalling as specified in standards at the time of this application.

It is noted that in all standardized CQI determination procedures, at the time of this application there is no notion of an improved CQI scheme that is tailored for high data rate cases (such as XR) where CBG-based transmission are used. One main idea behind the eCQI is to have control over CBG error probability and guarantee the delivery of a certain number of CBGs with a predefined probability criterion. In order to do so, these targets have to be agreed upon beforehand, for example using RRC messages, to let the UE know to change the CQI calculation process. Assume a maximum number of M CBGs is configured and the eCQI target is to have the probability of at most N failed CBGs not to exceed P. This will ensure that at worst case only N CBG may fail in the first transmission. Thus, they can be recovered by retransmission as only the failed CBGs will be retransmitted. Deciding on the values of these parameters is up to the network. Several improvements in terms of capacity enhancement for XR have been presented that show a gain for using eCQI compared to legacy methods.

One main challenge of the eCQI scheme is its potentially high computational complexity that may make it less attractive or infeasible for the UE vendors, unless smart low complexity implementations are developed. The complexity mainly comes from calculating a series of long probabilistic expressions before each CQI reporting instance. Such high complexity may cause several problems such as requiring a higher processor capacity, additional power consumption and added processing delays for CQI reporting. Note that a delayed CQI report may become irrelevant and lead to inaccurate link adaptation decisions.

Our main objective in example embodiments as disclosed herein are to facilitate the UE (device) implementation of another eCQI scheme, which for clarity in this application will be referred to as “the other eCQI scheme”, as proposed by the applicant and filed with the USPTO by the Applicant. In addition, a further objective is to propose an inventive low complexity UE implementation of the eCQI that is based on a novel closed-form expression for calculating the new CBG statistic that is used in eCQI to reduce the added complexity compared to the legacy CQI procedure.

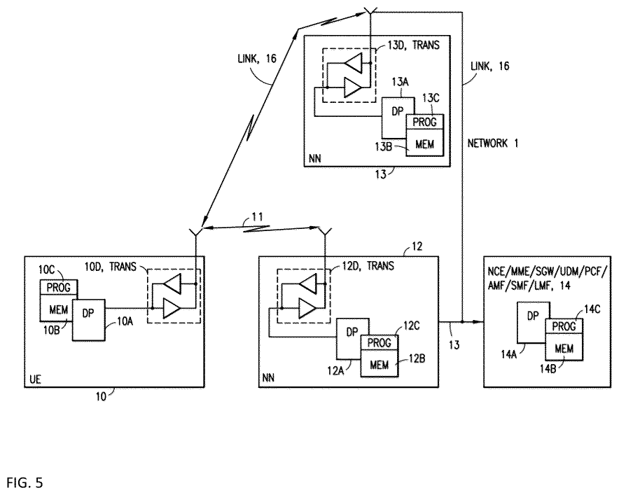

Before describing the example embodiments as disclosed herein in detail, reference is made to FIG. 5 for illustrating a simplified block diagram of various electronic devices that are suitable for use in practicing the example embodiments as disclosed herein.

FIG. 5 shows a block diagram of one possible and non-limiting exemplary system in which the example embodiments as disclosed herein may be practiced. In FIG. 5, a user equipment (UE) 10 is in wireless communication with a wireless network 1 or network, 1 as in FIG. 5. The wireless network 1 or network 1 as in FIG. 5 can comprise a communication network such as a mobile network for example, the mobile network 1 or first mobile network as disclosed herein. Any reference herein to a wireless network 1 as in FIG. 5 can be seen as a reference to any wireless network as disclosed herein. Further, the wireless network 1 as in FIG. 5 can also comprises hardwired features as may be required by a communication network. A UE is a wireless, typically mobile device that can access a wireless network. The UE, for example, may be a mobile phone (or called a “cellular” phone or a smartphone) and/or a computer with a mobile terminal function. For example, the UE or mobile terminal may also be a portable, pocket, handheld, computer-embedded or vehicle-mounted mobile device and performs a language signaling and/or data exchange with the RAN.

The UE 10 includes one or more digital processors DP 10A, one or more memories MEM 10B, and one or more transceivers TRANS 10D interconnected through one or more buses. Each of the one or more transceivers TRANS 10D includes a receiver and a transmitter. The one or more buses may be address, data, or control buses, and may include any interconnection mechanism, such as a series of lines on a motherboard or integrated circuit, fiber optics or other optical communication equipment, and the like. The one or more transceivers TRANS 10D which can be optionally connected to one or more antennas for communication to a Network Node (NN) 12 and/or a Network Node NN 13, respectively. The one or more memories MEM 10B include computer program code PROG 10C. The UE 10 communicates with NN 12 and/or NN 13 via a wireless link 11 and/or 16.

The NN 12 (NR/5G Node B, an evolved NB, or LTE device) is a network node such as a master or secondary node base station (for example, for NR or LTE long term evolution) that communicates with devices such as NN 13 and UE 10 of FIG. 5. The NN 12 provides access to wireless devices such as the UE 10 to the wireless network 1. The NN 12 includes one or more processors DP 12A, one or more memories MEM 12B, and one or more transceivers TRANS 12D interconnected through one or more buses. In accordance with the example embodiments these TRANS 12D can include X2 and/or Xn interfaces for use to perform the example embodiments as disclosed herein. Each of the one or more transceivers TRANS 12D includes a receiver and a transmitter. The one or more transceivers TRANS 12D can be optionally connected to one or more antennas for communication over at least link 11 with the UE 10. The one or more memories MEM 12B and the computer program code PROG 12C are configured to cause, with the one or more processors DP 12A, the NN 12 to perform one or more of the operations as described herein. The NN 12 may communicate with another gNB or eNB, or a device such as the NN 13 such as via link 16. Further, the link 11, link 16 and/or any other link may be wired or wireless or both and may implement, for example, an X2 or Xn interface. Further the link 11 and/or link 16 may be through other network devices such as, but not limited to an NCE/MME/SGW/UDM/PCF/AMF/SMF/LMF 14 device as in FIG. 5. The NN 12 may perform functionalities of an MME (Mobility Management Entity) or SGW (Serving Gateway), such as a User Plane Functionality, and/or an Access Management functionality for LTE and similar functionality for 5G.

The NN 13 can be associated with a mobility function device such as an AMF or SMF, further the NN 13 may comprise a NR/5G Node B or possibly an evolved NB a base station such as a master or secondary node base station (for example, for NR or LTE long term evolution) that communicates with devices such as the NN 12 and/or UE 10 and/or the wireless network 1. The NN 13 includes one or more processors DP 13A, one or more memories MEM 13B, one or more network interfaces, and one or more transceivers TRANS 13D interconnected through one or more buses. In accordance with the example embodiments these network interfaces of NN 13 can include X2 and/or Xn interfaces for use to perform the example embodiments as disclosed herein. Each of the one or more transceivers TRANS 13D includes a receiver and a transmitter that can optionally be connected to one or more antennas. The one or more memories MEM 13B include computer program code PROG 13C. For instance, the one or more memories MEM 13B and the computer program code PROG 13C are configured to cause, with the one or more processors DP 13A, the NN 13 to perform one or more of the operations as described herein. The NN 13 may communicate with another mobility function device and/or eNB such as the NN 12 and the UE 10 or any other device using, for example, link 11 and/or link 16 or another link. The Link 16 as shown in FIG. 5 can be used for communication between the NN 12 and the NN13. These links maybe wired or wireless or both and may implement, for example, an X2 or Xn interface. Further, as stated above the link 11 and/or link 16 may be through other network devices such as, but not limited to an NCE/MME/SGW device such as the NCE/MME/SGW/UDM/PCF/AMF/SMF/LMF 14 of FIG. 5.

The one or more buses of the device of FIG. 5 may be address, data, or control buses, and may include any interconnection mechanism, such as a series of lines on a motherboard or integrated circuit, fiber optics or other optical communication equipment, wireless channels, and the like. For example, the one or more transceivers TRANS 12D, TRANS 13D and/or TRANS 10D may be implemented as a remote radio head (RRH), with the other elements of the NN 12 being physically in a different location from the RRH, and these devices can include one or more buses that could be implemented in part as fiber optic cable to connect the other elements of the NN 12 to a RRH.

It is noted that although FIG. 5 shows a network nodes such as NN 12 and NN 13, any of these nodes can incorporate or be incorporated into an eNodeB or eNB or gNB such as for example LTE and NR, and would still be configurable to perform example embodiments as disclosed herein.

Also it is noted that description herein indicates that “cells” perform functions, but it should be clear that it can be the gNB that forms the cell and/or a user equipment and/or mobility management function device that will perform the functions. In addition, the cell makes up part of a gNB, and there can be multiple cells per gNB.

The wireless network 1 or any network it can represent may or may not include a NCE/MME/SGW/UDM/PCF/AMF/SMF/LMF 14 that may include (NCE) network control element functionality, MME (Mobility Management Entity)/SGW (Serving Gateway) functionality, and/or serving gateway (SGW), and/or MME (Mobility Management Entity) and/or SGW (Serving Gateway) functionality, and/or user data management functionality (UDM), and/or PCF (Policy Control) functionality, and/or Access and Mobility Management Function (AMF) functionality, and/or Session Management (SMF) functionality, and/or Location Management Function (LMF), and/or Authentication Server (AUSF) functionality and which provides connectivity with a further network, such as a telephone network and/or a data communications network (for example, the Internet), and which is configured to perform any 5G and/or NR operations in addition to or instead of other standard operations at the time of this application. The NCE/MME/SGW/UDM/PCF/AMF/SMF/LMF 14 is configurable to perform operations in accordance with example embodiments in any of an LTE, NR, 5G and/or any standards based communication technologies being performed or discussed at the time of this application. In addition, it is noted that the operations in accordance with example embodiments, as performed by the NN 12 and/or NN 13, may also be performed at the NCE/MME/SGW/UDM/PCF/AMF/SMF/LMF 14.

The NCE/MME/SGW/UDM/PCF/AMF/SMF/LMF 14 includes one or more processors DP 14A, one or more memories MEM 14B, and one or more network interfaces (N/W I/F(s)), interconnected through one or more buses coupled with the link 13 and/or link 16. In accordance with the example embodiments these network interfaces can include X2 and/or Xn interfaces for use to perform the example embodiments The one or more memories MEM 14B include computer program code PROG 14C. The one or more memories MEM14B and the computer program code PROG 14C are configured to, with the one or more processors DP 14A, cause the NCE/MME/SGW/UDM/PCF/AMF/SMF/LMF 14 to perform one or more operations which may be needed to support the operations in accordance with the example embodiments.

It is noted that the NN 12 and/or NN 13 and/or UE 10 can be configured (for example based on standards implementations etc.) to perform functionality of a Location Management Function (LMF). The LMF functionality may be embodied in any of these network devices or other devices associated with these devices. In addition, an LMF such as the LMF of the MME/SGW/UDM/PCF/AMF/SMF/LMF 14 of FIG. 5, as at least described below, can be co-located with UE 10 such as to be separate from the NN 12 and/or NN 13 of FIG. 5 for performing operations in accordance with example embodiments as disclosed herein.

The wireless Network 1 may implement network virtualization, which is the process of combining hardware and software network resources and network functionality into a single, software-based administrative entity, a virtual network. Network virtualization involves platform virtualization, often combined with resource virtualization. Network virtualization is categorized as either external, combining many networks, or parts of networks, into a virtual unit, or internal, providing network-like functionality to software containers on a single system. Note that the virtualized entities that result from the network virtualization are still implemented, at some level, using hardware such as processors DP10, DP12A, DP13A, and/or DP14A and memories MEM 10B, MEM 12B, MEM 13B, and/or MEM 14B, and also such virtualized entities create technical effects.

The computer readable memories MEM 12B, MEM 13B, and MEM 14B may be of any type suitable to the local technical environment and may be implemented using any suitable data storage technology, such as semiconductor based memory devices, flash memory, magnetic memory devices and systems, optical memory devices and systems, fixed memory and removable memory. The computer readable memories MEM 12B, MEM 13B, and MEM 14B may be means for performing storage functions. The processors DP10, DP12A, DP13A, and DP14A may be of any type suitable to the local technical environment, and may include one or more of general purpose computers, special purpose computers, microprocessors, digital signal processors (DSPs) and processors based on a multi-core processor architecture, as non-limiting examples. The processors DP10, DP12A, DP13A, and DP14A may be means for performing functions, such as controlling the UE 10, NN 12, NN 13, and other functions as described herein.

In general, various embodiments of any of these devices can include, but are not limited to, cellular telephones such as smart phones, tablets, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, tablets with wireless communication capabilities, as well as portable units or terminals that incorporate combinations of such functions.

Further, the various embodiments of any of these devices can be used with a UE vehicle, a High Altitude Platform Station, or any other such type node associated with a terrestrial network or any drone type radio or a radio in aircraft or other airborne vehicles or a vessel such as a or waterborne vessel or boat.

As similarly stated above, example embodiments as disclosed herein facilitate UE (device) implementation of the other eCQI scheme, as mentioned above and entitled “Optimized CQI feedback for code block group based transmissions for extended reality use cases” filed by the Applicant under application No. 63/324,186 with the U.S. patent office on Mar. 28, 2022. Propose an inventive low complexity UE implementation of the eCQI that is based on a novel closed-form expression for calculating the new CBG statistic that is used in eCQI to reduce the added complexity compared to the legacy CQI procedure. In accordance with example embodiments a measure for complexity reduction is the number of multiplications done for evaluating the right CQI index. Example embodiments as disclosed herein provide solutions that have linear complexity (with regards to M and N) as opposed to an exponential relation if eCQI is done via legacy methods. Furthermore, there is introduced new searching methods to determine the CQI index that can further reduce the number of computations.

It is noted that any reference to “the other eCQI scheme” by the Applicant as discussed above in this paper will be referring to this USPTO patent application No. 63/324,186 filed by the Applicant, the content of which is hereby incorporated in its entirety.

As stated in the other eCQI scheme as proposed by the applicant in USPTO patent application No. 63/324,186, start of the eCQI procedure begins with the following steps:
1) The gNB configures the UE to use eCQI (CBG optimized) reporting where the UE shall estimate highest supported MCS (expressed via a CQI index). This can be assuming that downlink transmissions occupy a group of downlink physical resource blocks termed the CSI reference resource with M code block groups, while the error probability of at most N failed code block groups does not exceed P. The UE should act such that in the transmission of M code block groups, at most N of them fail with a probability less than P. Parameters M, N, and P are configured by the network;
2) The UE performs measurements on the CSI reference resources to determine the received post detection SINR. Based on these measurements, the UE estimates the effective SINR for the M-different CBGs. The UE can then determine the highest MCS that it can support, while at most N of the M CBGs are in error with probability P. To conduct its estimation, it may include observations on previous CBG transmissions (for example burst error probabilities, correlations, etc.) to improve its estimate of the effective SINR. This may be implemented in the UE by having a table with CBG error rate vs effective SINR for the different MCSs.

The UE can decode the PDSCH transmission, where at most of N of the M CBGs are detected to be in error with probability P.

These operations may be adopted as a UE capability test requirement in 3GPP, for example, using a known channel environment and letting the gNB transmit according to the eCQI reports of the end-user and then monitoring the individual CBG ACK/NACKs for compliance.

Then some example embodiments as disclosed herein for eCQI complexity reduction can be summarized as follows:
3) The UE shall use low complexity expressions for each CQI index to evaluate if the probability of at most N out of M CBG failures is less than P. See detailed solution in the next section;
4) The UE can choose among several novel searching methods to find the right CQI index. The UE will choose the highest CQI index that satisfies the condition of having the probability of at most N out of M CBG failures is less than P.

Then, a last step of eCQI procedure from the other eCQI scheme as proposed in USPTO patent application No. 63/324,186 is performed:
5) The reporting of the CQI index will happen next such that an associated CQI scheme guides the gNB to conduct link adaptation for its PDSCH transmissions. The gNB may conduct link adaptation according to the eCQI index when scheduling PDSCH transmissions, say sending a large TB that consistent of M CBGs that may contain a full or partial XR information frame.

As general operations, the basic signalling flow between the serving cells gNB and the UE can be shown with a first step (Step #1), the gNB configures the UE to use the eCQI scheme (CBG aware). That is, the gNB configures the UE to use eCQI reporting where the UE shall estimate highest supported MCS (expressed via a CQI index), assuming that downlink transmissions occupy a group of downlink physical resource blocks termed the CSI reference resource with M code block groups, while the error probability of at most N failed code block groups does not exceed P. Parameters M, N, and P are configured by the network. The configuration of the UE to use eCQI also include corresponding physical layer resources to use for channel state measurements, and may involve parameters timeRestrictionForChannelMeasurements and timeRestrictionForInterferenceMeasurements for informing the UE of such measurement restrictions. The configuration of the UE to use eCQI may also include reporting criteria for when the UE shall transmit eCQI information to the gNB. The signalling in Step #1 will most likely be using RRC as part of the CSI-ReportConfig IE as defined in 3GPP TS 38.331. Existing RRC signalling is used to configure the maximum number of CBG for the UE, and M could per default use same value or alternatively be configured separately.

In a second step (Step #2), the UE performs measurements on the indicated reference resources to determine the received post detection SINR. Based on these measurements, the UE estimates the effective SINR for the M CBGs. Here, the UE may apply proprietary outer loop learning, where for example, the correlation among neighbor CBG errors is determined, and thus compensate its assessed effective SINR based on avoiding for example typical burst errors etc. The UE thereafter (or as part of its proprietary add-on process) determines the highest MCS that it can support, while at most N of the M CBGs are in error with probability P. This may be implemented in the UE by having a table with CBG error rate vs SINR for the different MCS's. Given this, the UE will know the probability of error for each of the M assumed CBGs for each MCS index i, denoted Pe(m,MCSi). If CBGs errors are assumed uncorrelated, the UE can apply simple probability theory calculations to determine the maximum supported MCS, while at most N of the M CBGs are in error with probability P. However, more advanced compensation is possible for the UE to achieve better performance.

In a third step (Step #3), the condition for the UE to report the eCQI is met. As for the legacy CQI schemes, the condition for reporting eCQI may be periodical reporting or event-based reporting. The reporting of the eCQI may be in the form of an eCQI index that points to a new eCQI table that enumerates the supported modulation scheme, effective code rate, and overall efficiency that it recommends the gNB to use for its PDSCH transmissions. The eCQI index may be expressed with a 3-5 bit word, although options where more, or fewer, bits are used for the eCQI index reporting are not excluded.

In a fourth step (Step #4), the gNB follows the UEs recommendation and transmits a large TB on the PDSCH with M CBGs, using the MCS in line with the latest received eCQI report. Assuming that the channel quality conditions at the UE has not changed too much since the measurements of the eCQI, the UE will decode the PDSCH Tx with at most N of the M CBGs in error with probability P. In a fifth step (Step #5), the UE feeds back the HARQ multi-bit feedback that expresses which CBGs may be in error, and in a sixth step (Step #6) the gNB transmits the corresponding HARQ retransmissions, containing reduced number of CBGs as compared to the first transmission.

Main advantages and benefits of example embodiments as disclosed herein include steps 3 and step 4 where a new method to efficiently calculate the expressions in eCQI determination with a linear complexity relation to M and N rather than exponential legacy relation. This complexity reduction can benefit UE to use less computational power leading to possible power saving or reduced processing latency. Besides, a new CQI index selection method can be used to reduce the amount of calculations even more. Use of the index selection method is not limited to eCQI cases only as it can be utilized for any legacy CQI determination scheme.

The advantages of eCQI method has been presented where obvious XR capacity gains are shown. These results motivate implementation of eCQI and thus, efficient techniques in the example embodiments can facilitate the UE procedures. It is noted that use of eCQI and low complexity techniques in accordance with example embodiments is not limited to XR services and they can be beneficial for any high throughput traffic type.

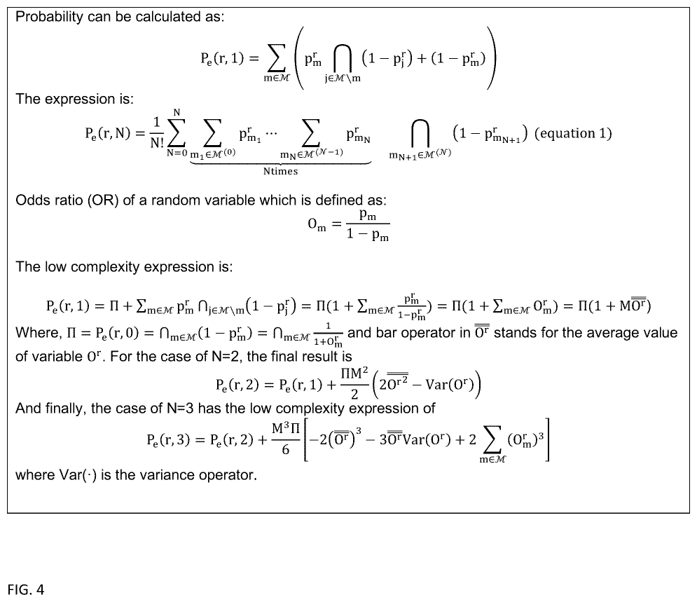

FIG. 4 shows probability calculations in accordance with example embodiments.

As shown in FIG. 4 and disclosed below there are description of details of a low complexity method by introducing the expressions required for the eCQI determination. Starting from the simplest case of N=1 which means the UE will report a CQI index that at most 1 CBG will fail out of M with probability no more than P, this probability can be calculated as:

Pₑ(r, 1)= [symbol] (pₘ^{r} [symbol] (1−pⱼ^{r})+(1−pₘ^{r}))
Where r is the CQI index, [symbol] is the set of CBGs={1, 2, . . . , M}, backslash \ is set exclusion operator (for example {1, 2}\{2}={1}), pₘ^{r} is the probability of error for CBG index m at CQI index r. For the general case of any arbitrary N<M, the expression is:

$${P}_{e} ( r , N ) = \frac{1}{N !} {\sum }_{N = 0}^{N} {\underbrace{{p}_{{m}_{1}}^{r} … {p}_{{m}_{N}}^{r}}}_{Ntimes} ( 1 - {p}_{{m}_{N + 1}}^{r} ) \qquad ( equation 1 )$$

As the probability of failure of N CBGs is summed for all the cases of N=0, 1, . . . N. Then, the UE compares this expression with the given target P. If Pₑ(r, N)<P and r is the highest value that can satisfy this inequality, then r is selected as the CQI index that should be reported to gNB for further link adaptation decisions.

However, complexity of calculating all the terms in above equation is high and in the order of

$$( \frac{1}{N !} {M}^{N + 1} )$$

which is exponential and may not be desirable by UE vendors to implement. We begin by calculating the expression above for most probable use cases such as N=1, 2 and 3 in closed-form that are less complex than direct calculation of the summations. As mentioned earlier, the maximum number of CBGs can be configured to M={2, 4, 6, 8}. Thus, for the cases of having a CBG error probability lower than 50%, valid values for N are 0, 1, 2, 3. Before starting to derive the closed-form solutions, we define the Odds Ratio (OR) of a random variable which is defined as:

$${O}_{m} = \frac{{p}_{m}}{1 - {p}_{m}}$$

that shows the ratio between success and failure probability of an event (CBG m's error probability for our case).

For the case of N=1, the low complexity expression is

$${P}_{e} ( r , 1 ) = \prod + {P}_{m}^{r} ( 1 - {p}_{j}^{r} ) = \prod ( 1 + \frac{{p}_{m}^{r}}{1 - {p}_{m}^{r}} ) = \prod ( 1 + {O}_{m}^{r} ) = \prod ( 1 + M \overline{\overline{{O}^{r}}} )$$

$$Where ,$$

$$\prod = {P}_{e} ( r , 0 ) = ( 1 - {p}_{m}^{r} ) = \frac{1}{1 + {O}_{m}^{r}}$$

and bar operator in O̅^̅{̅r̅}̅ stands for the average value of variable O^{r}. For the case of N=2, the final result is

$${P}_{e} ( r , 2 ) = {P}_{e} ( r , 1 ) + \frac{Π {M}^{2}}{2} ( 2 \overline{\overline{{O}^{r 2}}} - Var ( {O}^{r} ) )$$

And finally, the case of N=3 has the low complexity expression of

$${P}_{e} ( r , 3 ) = {P}_{e} ( r , 2 ) + \frac{{M}^{3} Π}{6} [ - 2 {( \overline{\overline{{O}^{r}}} )}^{3} - 3 \overline{\overline{{O}^{r}}} Var ( {O}^{r} ) + 2 {( {O}_{m}^{r} )}^{3} ]$$

where Var(⋅) is the variance operator

A main strength of these closed-form solutions is that they have all the repeated operations factored out, so each operation (such as averaging, variance, . . . ) is done only once and not repeated for every individual CBG. Consequently, the complexity of evaluating these expressions is drastically reduced to be in the order of [symbol] (NM) that is linear.

In accordance with example embodiments as disclosed herein the channel quality indicator configuration calculations are using a linear complexity relation with regards to parameter M and N rather than an exponential legacy relation.

Linear and exponential relationships differ in the way the y-values change when the x-values increase by a constant amount: In a linear relationship, the y-values have equal differences. In an exponential relationship, the y-values have equal ratios.

A linear function increases by a constant amount (the value of its slope) in each time interval, while an exponential function increases by a constant percentage (or ratio) in each time interval. In case with constant increments in x, a linear growth would increase by a constant difference, and an exponential growth would increase by a constant ratio.

One primary difference between exponential and linear functions is that the growth of an exponential function is proportional to the previous growth of a linear function is constant. The total attendance at a natural history museum can be modeled by the function f(x)=16,854(1.026)x.

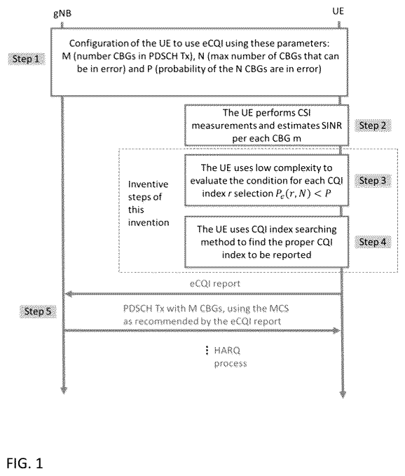

FIG. 1 shows a signaling flow between a serving cell gNB and a UE.

A simple schematic of the proposed solution is shown in Error! Reference source not found . . . Step 1, 2 and 5 are a part of the eCQI procedure as previously Submitted by the Applicant.

In the first 2 steps, the eCQI scheme is configured and the UE is responsible to measure and calculate per CBG SINR. Knowing the SINR of each CBG, the UE can estimate the error probability of each CBG.

As shown in step 1 of FIG. 1 the configuration of the UE to use eCQI using these parameters: M (number CBGs in PDSCH Tx), N (max number of CBGs that can be in error) and P (probability that the N CBGs are in error). Then as shown in step 2 of FIG. 1 the UE performs CSI measurements and estimates SINR per each CBG m.

Next, in steps 3 and 4, the UE uses the low complexity method to calculate the probability condition of Pₑ(r, N)<P for each CQI index r from one of the tables of standards at the time of this patent application. For further reduction of the computations, the UE can use a binary search to find the right r.

As shown in step 3 of FIG. 1 the UE uses low complexity to evaluate condition for each CQI index r selection per Pₑ(r,N)<P. Then as shown in step 4 of FIG. 1 the UE uses CQI index searching method to find proper CQI index to be reported.

Eventually, the highest r that can satisfy the condition is reported to the gNB. Then, the gNB uses the eCQI index as a recommendation from the UE to adapt the link and find the best MSC index for the PDSCH transmission.

It is noted that in accordance with example embodiments a condition determination of a channel quality indicator index can include a determination of for example, a lowest ‘x’ or highest ‘y’ error probability condition, that has a lowest or highest chance of an error condition as compared to all or some channel quality indicator indexes available for pending link adaptation decisions.

### CQI Index Searching Technique

Another main component in controlling the complexity the eCQI is the ordering method of different CQI indices. In other words, if the CQI index list is ordered in a smart way, a proper eCQI index can be found earlier which can save computations, time, and more importantly energy. More specifically, the UE has to calculate Equation 1, for each CQI index r and compare it with target P, then if the error is larger than the target, it will go to index r+1 and so on. Therefore, there will be a search space of CQI indices before the right r is found. Thus, the calculation of Equation 1 is repeated R times, where R is the size of the search space of r.

Therefore, there are studied and proposed different methods to minimize the size of searching space to find the best index. The legacy searching method is a simple incremental search. It means that the UE starts from CQI index=0 and checks the error probabilities and compares it with the target error probability P and continues to increase the index until the error rate exceeds the target. Then, the highest index that still provides an error probability below the target is reported as the CQI index to the gNB. Such an incremental search could lead to many unnecessary index checks and the complexity can be as high as F total number of CQI indices in the CQI tables. For instance F=16 in a Table specified in standards at the time of this patent application. This means that for the eCQI determination, the UE has to repeat calculating the probability expressions F times (or F/2 times on average) before reaching to the right CQI index.

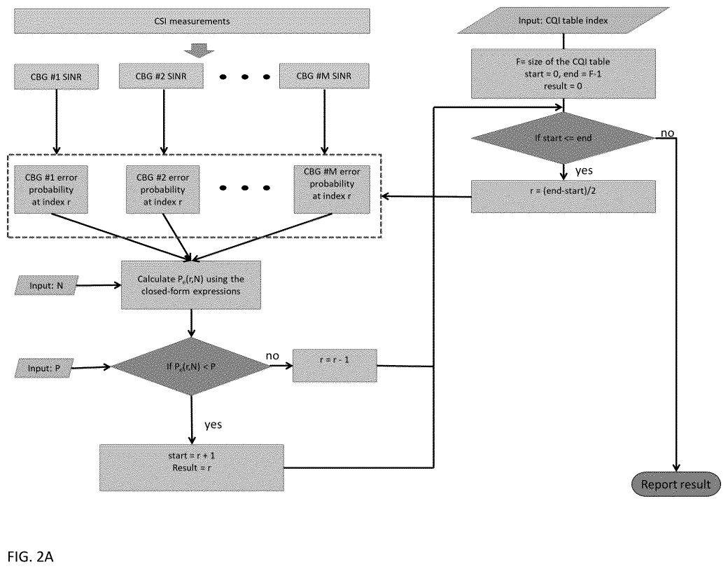

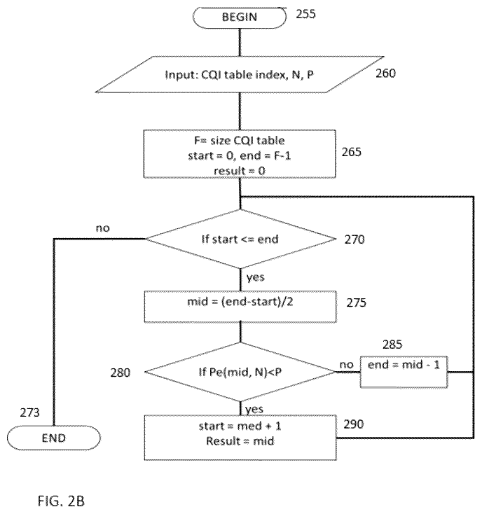

METHOD 1: In order to reduce the search space, the UE can incorporate a binary search method among the CQI indices. This algorithm is shown in FIG. 2. The UE starts from index F/2 and depending on the result of comparison with the predefined target, it will choose the next index to be the middle value between F/2 and F (in case the calculated error probability is less than the target) or 0 (in case the calculated error probability is higher than the target). This binary division and selection of the indices continues until the highest CQI index with an error probability below the error target is found. The complexity of this binary search is log(F)=4 that is less than F/2=8 for the F=16 values of tables specified at the time of this patent application.

METHOD 2: We can further reduce the search space size of the METHOD1 by regulating the comparison condition of Pₑ(r, N)<P to a more relaxed version. In this method the comparison criterion is changed to |Pₑ(r, N)−δ|<P where δ allows a small room for the error probability variation. This parameter can be chosen and signaled by the network to the UE. This method can reach to the CQI index faster than METHOD1 since it may choose some indices that violate the error target value by δ. Therefore, it is up to the network to decide between complexity reduction (or UE power saving) or target error rate requirement.

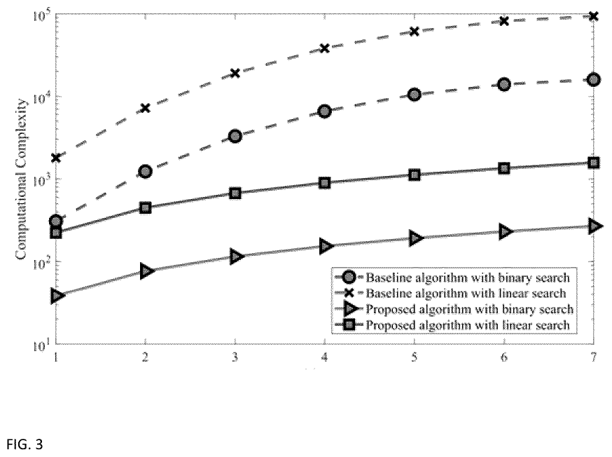

FIG. 3 shows a complexity comparison for a maximum number of failed CBGs (N) of a proposed low complexity method with baseline schemes in terms of multiplications.

A simulation plot is shown in FIG. 3 that is comparing the complexity of low complexity eCQI determination method with baseline direct computation method, both in linear and binary search schemes. The baseline algorithm is the case where Equation 1 is calculated directly by finding the summations one by one and multiplying them sequentially. Proposed algorithm is the closed form low-complexity expressions that require much less multiplications. Linear search method is the default legacy search, where the eCQI determination starts from r=0 up to r=16 in Tables of standards at the time of this patent application and the size of R scales the complexity of the eCQI determination algorithm (could be baseline or the proposed schemes). Finally, the binary search method that is illustrated in FIG. 2A and FIG. 2B and is nested within the eCQI calculation procedure.

FIG. 2A and FIG. 2B each show an algorithm for eCQI determination using the novel low-complexity solutions with a binary search of CQI indices

As shown in FIG. 2A there are CSI measurements for CBG #1, #2, . . . #M that include a SINR. This leads to error probabilities for CBG#1-#M at index r. Then as shown in FIG. 2A there is calculating with an input N, Pₑ(r,N) using closed form expressions. Then calculating if Pₑ(r,N)<P. Wherein if yes, then start=r+1, Result=r. Or if no, then reporting the result or starting further calculations on another CBG index r. These calculations are using an input from a CQI table index.

As shown in step 255 of FIG. 2B the operations begin. As shown in step 260 of FIG. 2B there is an input of CQI table index, N, and P. As shown in step 265 of FIG. 2B F=size of CQI table, start=0, end equals F−1, and result=0. As shown in step 270 of FIG. 2B if start<=end. If No, then as shown in step 273 of FIG. 2B the end. If yes, then as shown in step 275 of FIG. 2B mid=(end-start)/2. As shown in step 280 of FIG. 2B it is determined if Pe(mid, N)<P. If no then as shown in step 285 there is end=mid−1. If yes, then as shown in step 290 of FIG. 2B there is start=mid+1, and result=mid. It is noted that both steps 285 and 290 of FIG. 2B lead to performing step 270 of FIG. 2B.

As can be observed, the gain of implementing closed-form solutions+binary search is in multiple orders of magnitude (M=8 for this plot). For instance, for the case of N=4, this method requires 14 times less multiplications compared to a baseline+binary search solution and 120 times less multiplications compared to a baseline+linear search solution.

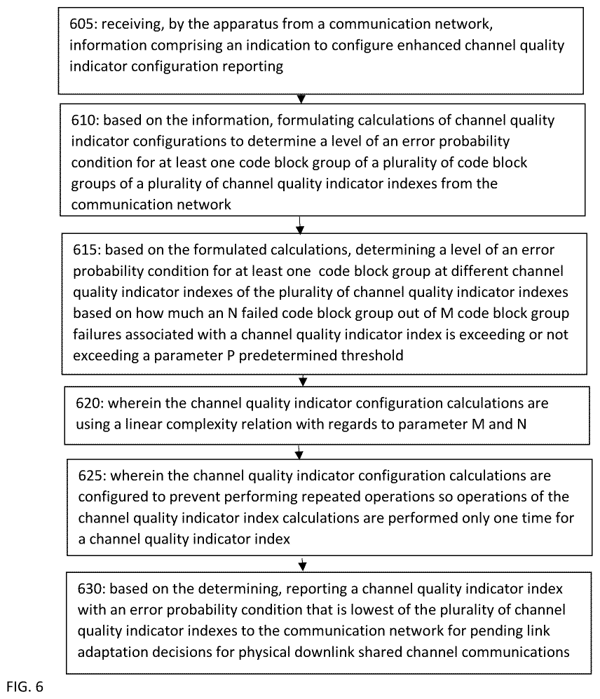

FIG. 6 shows a method in accordance with example embodiments which may be performed by an apparatus.

It is noted that any of these steps of FIG. 6 or the related paragraphs below may be performed in a different order or performed more than one time, and/or any of these steps may be skipped as needed for any operations as disclosed herein.

FIG. 6 illustrates operations which may be performed by a device such as, but not limited to, a device (for example, the UE 10 as in FIG. 5). As shown in step 605 of FIG. 6 there is receiving, by the apparatus from a communication network, information comprising an indication to configure enhanced channel quality indicator configuration reporting. As shown in step 610 of FIG. 6 there is, based on the information, formulating calculations of channel quality indicator configurations to determine a level of an error probability condition for at least one code block group of a plurality of code block groups of a plurality of channel quality indicator indexes from the communication network. As shown in step 615 of FIG. 6 there is, based on the formulated calculations, determining a level of an error probability condition for at least one code block group at different channel quality indicator indexes of the plurality of channel quality indicator indexes based on how much an N failed code block group out of M code block group failures associated with a channel quality indicator index is exceeding or not exceeding a parameter P predetermined threshold. As shown in step 620 of FIG. 6 wherein the channel quality indicator configuration calculations are using a linear complexity relation with regards to parameter M and N. As shown in step 625 of FIG. 6 wherein the channel quality indicator configuration calculations are configured to prevent performing repeated operations so operations of the channel quality indicator index calculations are performed only one time for a channel quality indicator index. Then as shown in step 630 of FIG. 6 there is, based on the determining, reporting a channel quality indicator index with an error probability condition that is the lowest of the plurality of channel quality indicator indexes to the communication network for pending link adaptation decisions for physical downlink shared channel communications.

In accordance with the example embodiments as described in the paragraph above, wherein the channel quality indicator index calculations are searching for the channel quality indicator index with an error probability lower than a target error threshold parameter P to be reported, comprising minimizing a size of a search space to find the channel quality indicator index.

In accordance with the example embodiments as described in the paragraphs above, wherein minimizing a size of a search space is using a binary search among different channel quality indicator indexes to find the channel quality indicator index for reporting, wherein the search is performed until a highest channel quality indicator index with an error probability below an error target is found.

In accordance with the example embodiments as described in the paragraphs above, wherein the minimizing a size of a search space is beginning from an index F/2.

In accordance with the example embodiments as described in the paragraphs above, wherein based on a maximum of N failed code block group out of the M code block group failures not exceeding the parameter P predetermined threshold a next chosen index is between the index F/2 and F.

In accordance with the example embodiments as described in the paragraphs above, wherein based on the probability of at most N failed code block group out of M (total number of code block groups within a transport block) exceeding the parameter P a next chosen index is between 0 and F/2.

In accordance with the example embodiments as described in the paragraphs above, wherein the calculations are regulating a comparison condition of Pₑ(r, N)<P to |Pₑ(r, N)−δ|<P where δ is limiting an error probability variation.

In accordance with the example embodiments as described in the paragraphs above, wherein a probability of failure of N code block groups of the plurality of code block groups is summed for all the cases of N=0, 1, . . . N, wherein the apparatus compares this expression with a given target P, and wherein if Pₑ(r, N)<P and r is a highest value channel quality indicator index that can meet a maximum error probability below parameter P condition, then r is selected as the channel quality indicator index reported to the communication network for the pending link adaptation decisions.

In accordance with the example embodiments as described in the paragraphs above, wherein the channel quality indicator configuration calculations comprise a calculation comprising:

$${P}_{e} ( r , N ) = \frac{1}{N !} {\sum }_{N = 0}^{N} {\underbrace{{p}_{{m}_{1}}^{r} … {p}_{{m}_{N}}^{r}}}_{Ntimes} ( 1 - {p}_{{m}_{N + 1}}^{r} ) . \qquad ( equation 1 )$$

In accordance with the example embodiments as described in the paragraphs above, wherein the apparatus is embodied in a user equipment of the communication network.

A non-transitory computer-readable medium (MEM 10B as in FIG. 5) storing program code (PROG 10C as in FIG. 5), the program code executed by at least one processor (DP 10A as in FIG. 5) to perform the operations as at least described in the paragraphs above.

In accordance with an example embodiment as described above there is an apparatus comprising: means for receiving (one or more transceivers 10D; MEM 10B; PROG 10C; and DP 10A as in FIG. 5), by the apparatus (UE 10 as in FIG. 5) from a communication network (Network 1 as in FIG. 5), information comprising an indication to configure enhanced channel quality indicator configuration reporting; means, based on the information, for formulating (one or more transceivers 10D; MEM 10B; PROG 10C; and DP 10A as in FIG. 5) calculations of channel quality indicator configurations to determine a level of an error probability condition for at least one code block group of a plurality of code block groups of a plurality of channel quality indicator indexes from the communication network; means, based on the formulated calculations, for determining (one or more transceivers 10D; MEM 10B; PROG 10C; and DP 10A as in FIG. 5) a level of an error probability condition for at least one code block group at different channel quality indicator indexes of the plurality of channel quality indicator indexes based on how much an N failed code block group out of M code block group failures associated with a channel quality indicator index is exceeding or not exceeding a parameter P predetermined threshold; wherein the channel quality indicator configuration calculations are using (one or more transceivers 10D; MEM 10B; PROG 10C; and DP 10A as in FIG. 5) a linear complexity relation with regards to parameter M and N; wherein the channel quality indicator configuration calculations are configured (one or more transceivers 10D; MEM 10B; PROG 10C; and DP 10A as in FIG. 5) to prevent performing repeated operations so operations of the channel quality indicator index calculations are performed only one time for a channel quality indicator index; and means, based on the determining, for reporting (one or more transceivers 10D; MEM 10B; PROG 10C; and DP 10A as in FIG. 5) a channel quality indicator index with an error probability condition that is lowest of the plurality of channel quality indicator indexes to the communication network for pending link adaptation decisions for physical downlink shared channel communications.

In the example aspect according to the paragraph above, wherein at least the means for receiving, formulating, determining, using, configuring, and reporting comprises a non-transitory computer readable medium [MEM 10B as in FIG. 5] encoded with a computer program [PROG 10C as in FIG. 5] executable by at least one processor [DP 10A as in FIG. 5].

Further, in accordance with example embodiments there is circuitry for performing operations in accordance with example embodiments as disclosed herein. This circuitry can include any type of circuitry including content coding circuitry, content decoding circuitry, processing circuitry, image generation circuitry, data analysis circuitry, etc.). Further, this circuitry can include discrete circuitry, application-specific integrated circuitry (ASIC), and/or field-programmable gate array circuitry (FPGA), etc. as well as a processor specifically configured by software to perform the respective function, or dual-core processors with software and corresponding digital signal processors, etc.). Additionally, there are provided necessary inputs to and outputs from the circuitry, the function performed by the circuitry and the interconnection (perhaps via the inputs and outputs) of the circuitry with other components that may include other circuitry in order to perform example embodiments as described herein.

In accordance with example embodiments as disclosed in this application this application, the “circuitry” provided can include at least one or more or all of the following:
(a) hardware-only circuit implementations (such as implementations in only analog and/or digital circuitry);
(b) combinations of hardware circuits and software, such as (as applicable):
(i) a combination of analog and/or digital hardware circuit(s) with software/firmware; and
(ii) any portions of hardware processor(s) with software (including digital signal processor(s)), software, and memory(ies) that work together to cause an apparatus, such as a mobile phone or server, to perform various functions, such as functions or operations in accordance with example embodiments as disclosed herein); and
(c) hardware circuit(s) and or processor(s), such as a microprocessor(s) or a portion of a microprocessor(s), that requires software (for example, firmware) for operation, but the software may not be present when it is not needed for operation.”

In general, the various embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the example embodiments are not limited thereto. While various aspects may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

Embodiments as disclosed herein may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

The word “exemplary” is used herein to mean “serving as an example, instance, or illustration.” Any embodiment described herein as “exemplary” is not necessarily to be construed as preferred or advantageous over other embodiments. All of the embodiments described in this Detailed Description are exemplary embodiments provided to enable persons skilled in the art to make or use of example embodiments of the invention and not to limit the scope of the invention which is defined by the claims.

The foregoing description has provided by way of exemplary and non-limiting examples a full and informative description of the best method and apparatus presently contemplated by the inventors for carrying out example embodiments of the invention. However, various modifications and adaptations may become apparent to those skilled in the relevant arts in view of the foregoing description, when read in conjunction with the accompanying drawings and the appended claims. However, all such and similar modifications of the teachings as disclosed herein will still fall within the scope of this invention.

It should be noted that the terms “connected,” “coupled,” or any variant thereof, mean any connection or coupling, either direct or indirect, between two or more elements, and may encompass the presence of one or more intermediate elements between two elements that are “connected” or “coupled” together. The coupling or connection between the elements can be physical, logical, or a combination thereof. As employed herein two elements may be considered to be “connected” or “coupled” together by the use of one or more wires, cables and/or printed electrical connections, as well as by the use of electromagnetic energy, such as electromagnetic energy having wavelengths in the radio frequency region, the microwave region and the optical (both visible and invisible) region, as several non-limiting and non-exhaustive examples.

Furthermore, some of the features of the preferred embodiments as disclosed herein could be used to advantage without the corresponding use of other features. As such, the foregoing description should be considered as merely illustrative of the principles of example embodiments of the invention, and not in limitation thereof.

1. An apparatus, comprising:
at least one processor; and
at least one non-transitory memory storing instructions that, when executed with the at least one processor, cause the apparatus at least to perform:
receiving, with the apparatus from a communication network, information comprising an indication to configure enhanced channel quality indicator configuration reporting;
based on the information, formulating calculations of channel quality indicator configurations to determine a level of an error probability condition for at least one code block group of a plurality of code block groups of a plurality of channel quality indicator indexes from the communication network;
based on the formulated calculations, determining a level of an error probability condition for at least one code block group at different channel quality indicator indexes of the plurality of channel quality indicator indexes based on how much an N failed code block group out of M code block group failures associated with a channel quality indicator index is exceeding or not exceeding a parameter P predetermined threshold,
wherein the channel quality indicator configuration calculations are using a linear complexity relation with regards to parameter M and N, and
wherein the channel quality indicator configuration calculations are configured to prevent performing repeated operations so operations of the channel quality indicator index calculations are performed only one time for a channel quality indicator index; and
based on the determining, reporting a channel quality indicator index with an error probability condition that is lowest of the plurality of channel quality indicator indexes to the communication network for pending link adaptation decisions for physical downlink shared channel communications.

2. The apparatus of claim 1, wherein the channel quality indicator index calculations are searching for the channel quality indicator index with an error probability lower than a target error threshold parameter P to be reported, wherein the instructions, when executed with the at least one processor, cause the apparatus to perform minimizing a size of a search space to find the channel quality indicator index.

3. The apparatus of claim 2, wherein the instructions, when executed with the at least one processor, cause the apparatus to perform minimizing a size of a search space using a binary search among different channel quality indicator indexes to find the channel quality indicator index for reporting, wherein the search is performed until a highest channel quality indicator index with an error probability below an error target is found.

4. The apparatus of claim 2, wherein the minimizing a size of a search space is beginning from an index F/2.

5. The apparatus of claim 4, wherein based on a maximum of N failed code block group out of the M code block group failures not exceeding the parameter P predetermined threshold a next chosen index is between the index F/2 and F.

6. The apparatus of claim 4, wherein based on the probability of at most N failed code block group out of M exceeding the parameter P a next chosen index is between 0 and F/2.

7. The apparatus of claim 2, wherein the instructions, when executed with the at least one processor, cause the calculations to regulate a comparison condition of Pₑ(r, N)<P to |Pₑ(r, N)−δ|<P where δ is limiting an error probability variation.

8. The apparatus of claim 1, wherein a probability of failure of N code block groups of the plurality of code block groups is summed for all the cases of N=0, 1, . . . N, wherein the instructions, when executed with the at least one processor, cause the apparatus to compare this expression with a given target P, and wherein if Pₑ(r, N)<P and r is a highest value channel quality indicator index that can meet a maximum error probability below parameter P condition, then r is selected as the channel quality indicator index reported to the communication network for the pending link adaptation decisions.

9. The apparatus of claim 1, wherein the channel quality indicator configuration calculations comprise a calculation comprising:
$${P}_{e} ( r , N ) = \frac{1}{N !} {\sum }_{N = 0}^{N} {\underbrace{{p}_{{m}_{1}}^{r} … {p}_{{m}_{N}^{r}}}}_{Ntimes} ( 1 - {p}_{{m}_{N + 1}}^{r} ) .$$

10. The apparatus of claim 1, wherein the apparatus is embodied in a user equipment of the communication network.

11. A method, comprising:
receiving, with the apparatus from a communication network, information comprising an indication to configure enhanced channel quality indicator configuration reporting;
based on the information, formulating calculations of channel quality indicator configurations to determine a level of an error probability condition for at least one code block group of a plurality of code block groups of a plurality of channel quality indicator indexes from the communication network;
based on the formulated calculations, determining a level of an error probability condition for at least one code block group at different channel quality indicator indexes of the plurality of channel quality indicator indexes based on how much an N failed code block group out of M code block group in one transport block associated with a channel quality indicator index is exceeding or not exceeding a parameter P predetermined threshold,
wherein the channel quality indicator configuration calculations are using a linear complexity relation with regards to parameter M and N, and
wherein the channel quality indicator configuration calculations are configured to prevent performing repeated operations so operations of the channel quality indicator index calculations are performed only one time for a channel quality indicator index; and
based on the determining, reporting a channel quality indicator index with an error probability condition that is lowest of the plurality of channel quality indicator indexes to the communication network for pending link adaptation decisions for physical downlink shared channel communications.

12. The method of claim 11, wherein the channel quality indicator index calculations are searching for the channel quality indicator index with an error probability lower than a target error threshold parameter P to be reported, comprising minimizing a size of a search space to find the channel quality indicator index.

13. The method of claim 12, wherein minimizing a size of a search space is using a binary search among different channel quality indicator indexes to find the channel quality indicator index for reporting, wherein the search is performed until a highest channel quality indicator index with an error probability below an error target is found.

14. The method of claim 12, wherein the minimizing a size of a search space is beginning from an index F/2.

15. The method of claim 14, wherein based on a maximum of N failed code block group out of the M code block group failures not exceeding the parameter P predetermined threshold a next chosen index is between the index F/2 and F.

16. The method of claim 14, wherein based on the probability of at most N failed code block group out of M exceeding the parameter P a next chosen index is between 0 and F/2.

17. The method of claim 12, wherein the calculations are regulating a comparison condition of Pₑ(r, N)<P to |Pₑ(r, N)−δ|<P where δ is limiting an error probability variation.

18. The method of claim 11, wherein a probability of failure of N code block groups of the plurality of code block groups is summed for all the cases of N=0, 1, . . . N, wherein the apparatus compares this expression with a given target P, and wherein if Pₑ(r, N)<P and r is a highest value channel quality indicator index that can meet a maximum error probability below parameter P condition, then r is selected as the channel quality indicator index reported to the communication network for the pending link adaptation decisions.

19. The method of claim 11, wherein the channel quality indicator configuration calculations comprise a calculation comprising:
$${P}_{e} ( r , N ) = \frac{1}{N !} {\sum }_{N = 0}^{N} {\underbrace{{p}_{{m}_{1}}^{r} … {p}_{{m}_{N}^{r}}}}_{Ntimes} ( 1 - {p}_{{m}_{N + 1}}^{r} ) .$$

20. The method of claim 11, wherein the apparatus is embodied in a user equipment of the communication network.

21. A non-transitory program storage device readable with an apparatus tangibly embodying a program of instructions executable with the apparatus for performing the method of claim 11.
